(19) United States
(12) Patent Application Publication
(10) Pub. No.: US 2006/0249990 A1
(43) Pub. Date: Nov. 9, 2006

(54) PANEL LOADING DEVICE OF CAR AUDIO SYSTEM

(76) Inventor: JOUNG HOON LEE, Icheon-shi, Kyungki-do (KR)

Correspondence Address: IPLA P.A., 3580 WILSHIRE BLVD., 17TH FLOOR, LOS ANGELES, CA, 90010, US

(21) Appl. No.: 11/308,043

(22) Filed: Mar. 3, 2006

(30) Foreign Application Priority Data
Apr. 22, 2005 (KR) 10-2005-0033617

(51) Int. Cl. B60J 7/185

(52) U.S. Cl. 296/224

(57) ABSTRACT

A panel loading device of a car audio system is provided. The device includes: a panel having an open key button in front; a pair of first links hinged at one end to an inner and uppermost end of the panel respectively, and having a link pin at the other end; a pair of second links each having one end hinged to an inner and uppermost end of the panel; a guide plate having a vertical long hole through which the link pin of the first link is slidingly inserted, and a pair of horizontal long holes; a connecting shaft connected to both lower ends of the second links; a shaft gear connected to one end of the connecting shaft; and a motor driver for forwardly and reversely rotating the shaft gear depending on operation of the open key button.

### BACKGROUND OF THE INVENTION

1. Field of the Invention

The present invention relates to a car audio system, and more particularly, to a panel loading device of a car audio system.

2. Description of the Related Art

In general, a car is equipped with a car audio system having an audio function such as a cassette tape player, a compact disk player, and a radio. The car audio system is classified into two types where a front panel is fixed and loaded.

FIG. 1 is side views illustrating constructions of conventional panel loading devices of car audio systems. As shown in FIG. 1, in the conventional panel loading devices, even after the panel is fully opened, it covers a part of a front surface of the car audio system and therefore, there is a drawback in that only a storage medium of a very thin form such as a compact disk or a memory stick can be inserted into the car audio system.

In other words, the conventional panel loading devices merely have utilization degrees of front space of 26.48% (top view), 67.2% (middle view), and 73.38% (bottom view), respectively and, accordingly the storage medium capable of being installed and removed through the front surface of the car audio system has no choice but to be extremely limited in kind.

### SUMMARY OF THE INVENTION

Accordingly, the present invention is directed to a panel loading device of a car audio system that substantially overcomes one or more of the limitations and disadvantages of the conventional art.

One object of the present invention is to provide a panel loading device of a car audio system in which, when a panel is opened, it is sufficiently pushed out, thereby facilitating to insert a storage medium of a variety of thickness through a front of the car audio system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a panel loading device of a car audio system, the device including: a panel having an open key button in front; a pair of first links hinged at one end to an inner and uppermost end of the panel respectively, and having a link pin at the other end; a pair of second links each having one end hinged to an inner and uppermost end of the panel; a guide plate having a vertical long hole through which the link pin of the first link is slidingly inserted, and a pair of horizontal long holes; a connecting shaft connected to both lower ends of the second links; a shaft gear connected to one end of the connecting shaft; and a motor driver for forwardly and reversely rotating the shaft gear depending on operation of the open key button.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 is side views illustrating constructions of conventional panel loading devices of car audio systems;

FIG. 2 is a plan view illustrating a construction of a panel loading device of a car audio system according to a preferred embodiment of the present invention;

FIGS. 3A and 3B are side views illustrating constructions of panel loading devices of car audio systems according to a preferred embodiment of the present invention; and

FIG. 4 is a side view illustrating a construction of a panel loading device of a car audio system according to a preferred embodiment of the present invention.

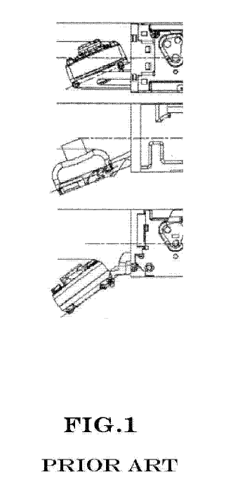

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

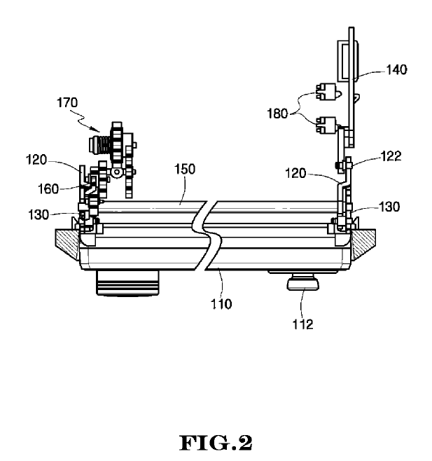

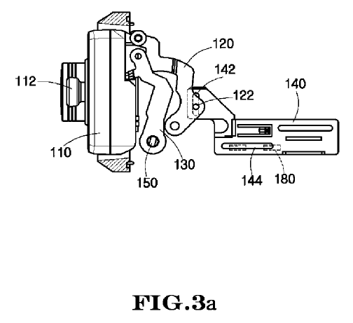

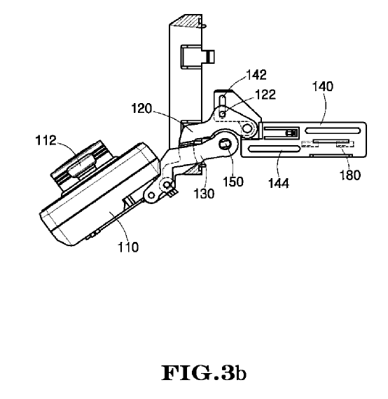

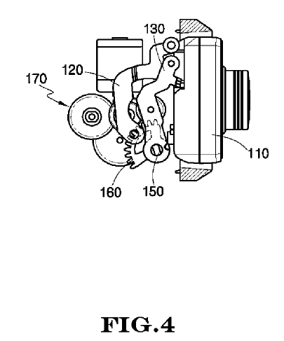

FIG. 2 is a plan view illustrating a construction of a panel loading device of a car audio system according to a preferred embodiment of the present invention, FIGS. 3A and 3B are side views illustrating the constructions of the panel loading devices of the car audio systems according to a preferred embodiment of the present invention, and FIG. 4 is a side view illustrating the construction of the panel loading device of the car audio system according to a preferred embodiment of the present invention.

As shown in FIGS. 2 to 4, the inventive panel loading device of the car audio system includes a panel 110, a first link 120, a second link 130, a guide plate 140, a connecting plate, a connecting shaft 150, a shaft gear 160, and a motor driver 170, and further includes a switch connector 180.

The panel 110 is installed in front of the car audio system, and is opened or closed when a storage medium is installed or removed. The panel 110 includes an open key button 112 in its front, and can include a separate display part. The open key button 112 is an operating button for allowing a user to open or close the panel 110.

The first links 120 are a pair of link members connected with the panel 110. Each of the first links 120 has one end hinged to an inner and uppermost end of the panel 110. One of the first links 120 includes a link pin 122 at one end, and is hinged at the other end to inside of the car audio system.

The second links 130 are a pair of link members connected with the panel 110 together with the first link 120. The second link 130 has one end hinged to the inner and upper most end of the panel 110 and has the other end coupled with the connecting shaft 150.

The guide plate 140 is a plate type member for supporting one of the first links 10. The guide plate 140 has a vertical long hole 142 through which the link pin 122 of the first link 120 is slidingly inserted, and a pair of horizontal long holes 144. The guide plate 140 moves to the front and rear depending on rotation or non-rotation of and rotation degree of the second link 130.

The connecting shaft 150 is a member for transmitting a rotary force and inter-working link structures at both sides. The connecting shaft 150 is connected to both lower ends of the second links 130, respectively.

The shaft gear 160 is a means for transmitting a rotary force of the motor driver 170 to the connecting shaft 150. The shaft gear 160 is connected to one end of the connecting shaft 150.

The motor driver 170 is a means for rotating the first and second links 120 and 130, and providing a driving force so that the panel 110 can be opened/closed. The motor driver 170 forwardly and reversely rotates the shaft gear 160 depending on operation of the open key button.

The switch detector 180 is a sensing means for sensing a movement position of the guide plate 140, and switching to supply a voltage to the motor driver 170.

### EMBODIMENT

In a result of application of the inventive panel loading device to a car audio system having a size of 50 mm based on Deutsche Industrie Normen (DIN), the panel has a rotary angle of 117° and accordingly, has a utilization degree of space increasing to 84%, thereby making it possible to install or remove various storage media such as a compact disk, a memory stick, a secure digital (SD) card, a universal serial bus (USB), and a hard disk drive (HDD).

As described above, the inventive panel loading device of the car audio system can increase the rotary angle of the panel and accordingly, maximize the utilization degree of front space, thereby not only installing or removing various storage media irrespective of thickness but also eliminating a limitation in design.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A panel loading device of a car audio system, the device comprising:
a panel having an open key button in front;
a pair of first links hinged at one end to an inner and uppermost end of the panel respectively, and having a link pin at the other end;
a pair of second links each having one end hinged to an inner and uppermost end of the panel;
a guide plate having a vertical long hole through which the link pin of the first link is slidingly inserted, and a pair of horizontal long holes;
a connecting shaft connected to both lower ends of the second links;
a shaft gear connected to one end of the connecting shaft; and
a motor driver for forwardly and reversely rotating the shaft gear depending on operation of the open key button.

2. The device according to claim 1, further comprising a switch detector for sensing a movement position of the guide plate.
